(19) United States
(12) Patent Application Publication
(10) Pub. No.: US 2005/0015301 A1
(43) Pub. Date: Jan. 20, 2005

(54) Method and apparatus for automated food court operation

(76) Inventor: Neldon P. Johnson, Salem, UT (US)

Correspondence Address: J. David Nelson;NELSON, SNUFFER, DAHLE & POULSEN, P.C., 10885 South State Street, Sandy, UT, 84070, US

(21) Appl. No.: 10/620,935

(22) Filed: Jul. 16, 2003

(51) Int. Cl. G06F 17/60

(52) U.S. Cl. 705/15

(57) ABSTRACT

A method and apparatus for automated food court operation utilizing an order station where a customer uses a touch screen to order menu items from one or more of the restaurants, a payment station where the customer uses a touch screen to pay for the order using forms of payment selected by the customer, a restaurant touch screen in each restaurant which notifies restaurant personnel of menu items ordered from the restaurant and allows restaurant personnel to acknowledge readiness of the items for delivery, a delivery screen in the dining area which notifies customers of items ready for delivery, and a central computer linking all of the components and providing sales and accounting information for distribution of revenue to the restaurants.

### FIELD OF THE INVENTION

The present invention is in the field of methods and apparatuses for automated purchase transactions, and in the particular field of methods and apparatuses for automated self-service ordering, payment and fulfillment of transactions within a food court environment.

### BACKGROUND OF THE INVENTION

Limited automation payment terminals for payment with cash, credit and check are well known and are gaining widespread use. Generally, such equipment comprises a credit/debit/check card reader and/or a currency/coin acceptor and a currency/coin dispenser. Many public telephones now provide for payment with coins, currency or credit/debit cards. Similarly, some vending machines and certain self-service facilities such as car washes accept coin, currency and credit/debit cards. Many grocery stores now have customer activated credit/debit/EBT card readers at each checkout stand, which require varying degrees of cashier assistance or interaction. Similarly many automobile service stations and convenience stores now have self-service credit/debit card readers built into the fuel pump controls.

The inventor of the present invention has a prior issued patent, U.S. Pat. No. 4,787,467 to Johnson, for an automated check out system that can be used in any retail setting that provides for self-pay with cash or credit/debit card. That invention provides for a customer to self-scan the bar code of each merchandise item to be purchased. Merchandise verification is accomplished by monitoring merchandise item weight. Other inventions disclosed in the prior art references provide varying levels of automation and security in the transaction payment setting.

Increasing automation of the purchase process offers a number of potential advantages by reducing transaction time, reducing labor costs, increasing profits, reducing prices to customers, reducing customer and employee theft, reducing fraud losses, increasing collectability of credit/debit/EBT card purchases, increasing collectability of check purchases and reducing risk to personnel. Until the present invention, potential use of automation in food court settings has been limited simply to the use of credit cards and debit cards for payment.

The nature of a food court is to provide customers with a variety of food choices while at the same time reducing cost to the restaurateurs by providing common dining, access and parking areas and common services such as heating and cooling. Further, the attraction of larger numbers of customers to the food court provides an added exposure benefit. Food courts are common in shopping malls which provide mall customers with convenient and diverse dining opportunities, thereby enhancing the shopping experience. The attraction for food providers is the steady flow of potential customers, lower overhead costs, and fewer problems associated with the shared dining area, restroom facilities janitorial services, and other support services and facilities.

Network shopping sites are found on the Internet, which utilize a shared shopping and payment process linked to affiliated websites. The Internet process centralizes ordering, payment and shipping and therefore increases efficiency. However, the efficiency is partially derived from the fact that delivery is also centralized through the provider. Such strategies cannot be utilized in a food court setting, as each restaurant or other food service business must prepare and serve food items individually and must, therefore, maintain a greater degree of autonomy. For purposes of this application, the term “restaurant” shall be defined to include a traditional restaurant, as well as a cafe, fast food vendor, or any other food item service business such as a coffee shop, an ice cream shop or the like. A method and apparatus for automated food court operation must allow each restaurant the autonomy necessary for quality control, fast service, accounting and the like.

None of the prior art automation systems disclosed provide for automation in a food court or similar setting while simultaneously providing for autonomy of each restaurant in accounting, food preparation and quality control. Furthermore, none of the systems disclosed provide for full automation transaction capabilities and the theft and fraud prevention capabilities needed in the modern transaction setting. Desired automation transaction capability would provide for the acceptance, at least, of personal checks, cash, coin, coupons, and credit/debit/EBT cards. It could also provide for the acceptance of biometric cards, wireless transfer of currency and could provide for the utilization of interactive touch or speech commands, merchandise bar codes, biometric verification of the customer, wireless data transfer, and personal identification card and facial image recording. It would also simultaneously provide an order routing system to individual restaurants, a notification system to customers for completed orders, and/or an automated identification system for the receiving and fulfillment of completed orders whether within the building or outside the building. It may also provide for Internet placement of advance orders with in-restaurant pickup at a pre-selected time.

An objective of the present invention is to provide a fully automated order, payment and delivery fulfillment method and apparatus for purchase transactions in a food court environment.

It is a further objective of the present invention to provide a fully automated order, payment and delivery fulfillment method and apparatus that further reduces or eliminates the need for a cashier or clerk for ordering and purchase payment transactions.

It is a further objective of the present invention to allow consumers to order and pay for items from different restaurants in a food court environment while physically remaining in a single location.

It is a further objective of the present invention to reduce the need for service personnel related to food court restaurant facilities.

It is a further objective of the present invention to provide an order, payment and delivery fulfillment method and apparatus that provides increased security against theft or fraud losses to both the restaurant owners and the customers.

It is a further objective of the present invention to provide a fully automated order, payment and delivery method and apparatus that provides an accurate and timely accounting of items sold and income realized to each individual restaurant owner.

### SUMMARY OF THE INVENTION

The present invention provides a method and apparatus for fully automated purchase transactions in a food court environment. In so doing, the ordering, payment and service aspects of a purchase transaction are automated for maximum efficiency and economic benefit. The present invention can eliminate some or all of the services normally provided in a fast food restaurant by checkers, cashiers and attendants. Similarly, the present invention can eliminate some or all of the services normally completed by clerks and other service personnel at restaurants in receiving and processing payments, and performing related support services. The present invention can further eliminate or reduce the services normally provided by clerks, cashiers and attendants for tax payment receiving and processing.

In the restaurant purchase setting, the transaction center of the present invention provides multiple stages for the processing of a purchase transaction. In the first, or ordering, stage, an order station presents the customer a selection of menus for the various restaurants in the food court. The customer may indicate a selection through use of a touch screen or other input device, thereby generating an order. Afterwards, the order is given an identifying code and a receipt is printed for the customer. The order is then parsed into components for the individual restaurants and the components are forwarded to the individual restaurants. An order may or may not be held in abeyance until the payment step of the method is completed.

A payment station may be incorporated into the present invention, which provides for the customer to self-process the customer's order and determine the amount owed for the order. Initially, the payment station is equipped with an input device so as to allow the customer to identify an order. The input device could be a bar code scanner, touch screen, biometric sensor or interactive audio with speech recognition. The payment station provides for payment by currency, coin, check, credit card, debit card, EBT card, coupon, or biometric card, as well as any other method accepted by the food court operator. The customer selects the method or methods of payment by interaction with the payment station through a touch monitor or through interactive audio with speech recognition, or merely proceeds with the activation of payment options by inserting payment forms into appropriate acceptor mechanisms. In addition, the payment station may also provide for transaction validation and fraud prevention through identification card input and recording, biometric input and recording, facial image input and recording, and/or signature verification. If payment is entirely or partially by check, the payment station may also print the name of the payee and the correct amount on the check after a signed check is inserted into the acceptor. The check can be retained in the payment station or can be returned to the customer as a processed and canceled check. The payment station will also dispense currency and/or coin change when payment is by currency and/or coin or a change back transaction is authorized when payment is by check or card. Payment status and identity verification are then forwarded to the service apparatus, clearing the order for preparation and pickup. In an alternative embodiment, the ordering and payment stations are contained in a single unit.

The service apparatus is used for accomplishing two steps in the method and has a receiving terminal in each restaurant for displaying selected menu items from the restaurant. When selected menu items are displayed with identifying information, food is prepared to the order's specifications and restaurant personnel indicate completion through an input device such as a touch screen, keyboard, or audio processor with speech recognition. Order completion status is displayed on monitors throughout the food court area, notifying the customer of completion of particular components of the order. Upon arrival at the restaurant, the customer presents the receipt and/or some other identifying feature, such as the verification input given to the payment station in order to receive the ordered items. In an alternative embodiment, order fulfillment is processed through an automated delivery system comprised of a computerized conveyer or similar item.

Finally, an accounting apparatus tabulates orders filled by each restaurant an disseminates the information to relevant parties.

Biometric cards for account debiting or crediting and/or credit purchases, and biometric input and imaging for use of biometric cards and for transaction validation and fraud prevention, may utilized fingerprints, hand prints, hand geometry, facial geometry, thermal patterns, retina patterns, DNA data or any other unique biological feature of the consumer.

### BRIEF DESCRIPTION OF THE DRAWINGS

FIG. 1 is a flowchart depicting the preferred method according to the present invention.

FIG. 2 is a schematic of a preferred apparatus according to the present invention.

FIG. 3 is the schematic of another preferred embodiment, featuring an automated conveyer delivery system.

### DETAILED DESCRIPTION OF THE PREFERRED EMBODIMENT

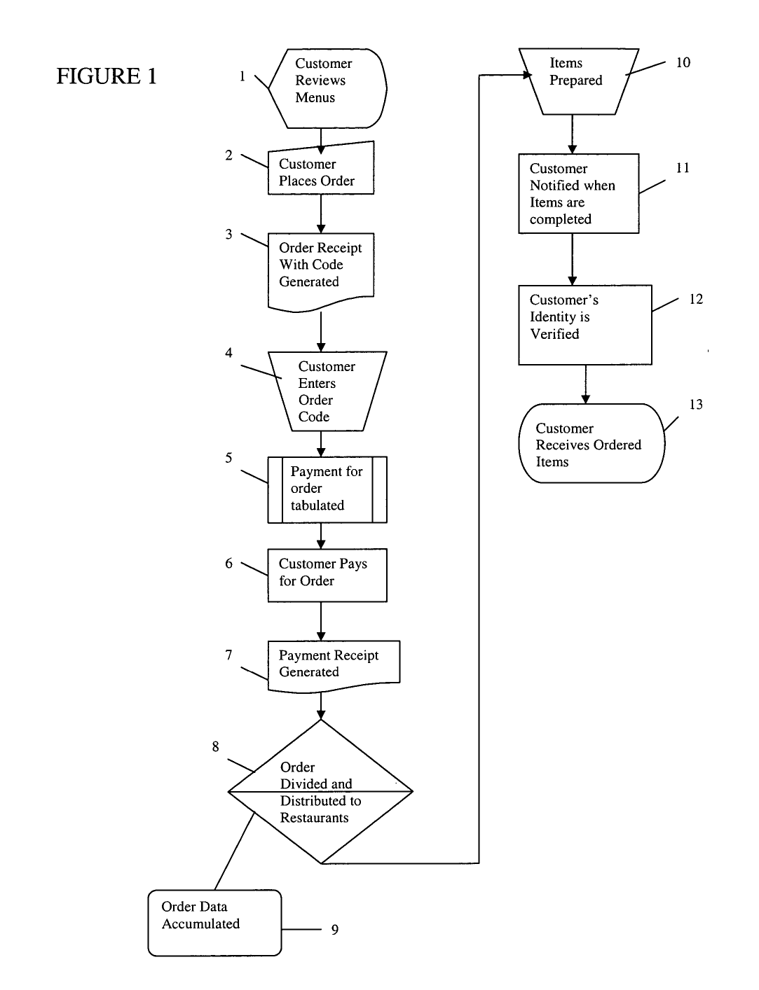

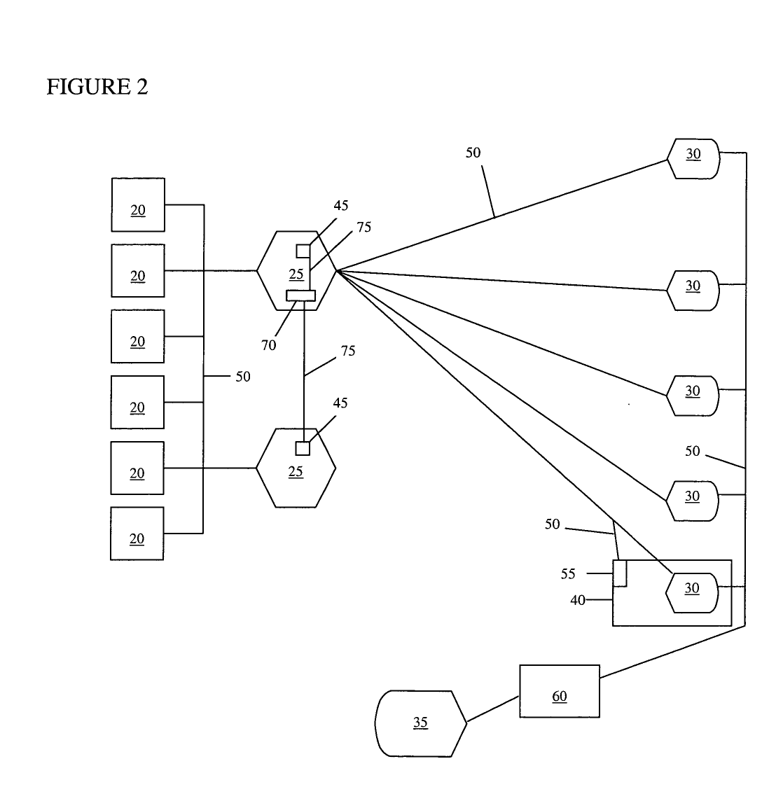

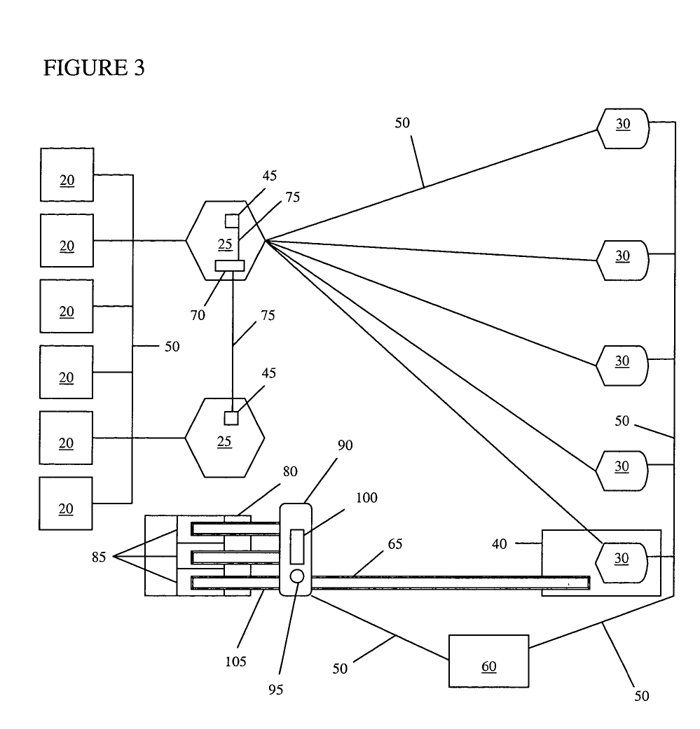

A preferred embodiment of the method of the present invention is shown in FIG. 1 Preferred embodiments of the apparatus of the present invention are disclosed in FIGS. 2 and 3

Referring to FIG. 2, the embodiment of apparatus of the present invention shown is comprised of order means, which, for the embodiment shown, comprises one or more order stations 20; payment means, which, for the embodiment shown comprises one or more payment stations 25; service means, which, for the embodiment shown, comprises a plurality of restaurant screens 30 with one or more restaurant screens located in each restaurant 40, the restaurant screens preferably being touch screens allowing restaurant personnel to confirm the readiness of selected menu items for delivery to the customer; at least one delivery display 35; computer means comprising a processor 60 and memory 45, which, for the embodiment shown, are incorporated in a central computer 70 located in one of the payment stations. However, the central computer may be located at a separate location, such as an office at the food court or at a remote location connected via internet, telephone or wireless connection to the food court. The order means, the payment means, and the service means are interconnected with the computer means by connection means 50 known in the art, which can be wire or wireless, interconnecting the order stations, payment stations, restaurant screens, delivery display, and the computer means as shown in FIG. 2. The central computer will have accounting means which for preferred embodiments will include software for providing menu item sales and revenue data for each restaurant.

Each restaurant 40 may also have an electronic identity verification means 55 that is also interconnected with the payment stations and the service means by the connection means and the computer means. For ease of comprehension, only a single restaurant 40 and delivery display device 35 are depicted. Also, as noted above, for purposes of this application, including the detailed description and the claims, the term “restaurant” has been defined to include a traditional restaurant as well as a cafe, fast food vendor or any other food item service business such as a coffee shop, an ice cream shop or the like.

Referring to FIG. 1, in practice, the method according to the present invention begins as a customer enters a food court and views menus 1 displayed on an order station, which is interconnected with a central computer. After reviewing the menus, the customer places an order 2 by indicating desired items. An order receipt is generated 3. The order receipt contains a code identifying the order for use later in the method. The customer then proceeds to a payment station and enters the order code 4. The payment station, through communication with the central computer, tabulates the cost of the order and requests payment from the customer 5. The customer pays for the order 6 and a payment receipt is generated 7. After payment is made, the central computer sorts order data 8 and routes order information 8 to relevant restaurants and stores statistical order data 9 for use by the restaurants in determining menu item volume, profitability and other desired information for the restaurants. When information regarding specific items for an order are received, each restaurant then prepares its portion of the order 10 and notifies the customer when the items are ready 11. The customer then proceeds to the restaurant, identifies himself 12 and receives the items 13. For more detailed description, the method and associated apparatus can be divided into four phases.

A. Ordering Phase:

The ordering phase accomplishes the customer's selection of items and processes those selected items into an order. A preferred embodiment of the order station 20 would incorporate a touch screen. The display processor and touch processing apparatus of the touch screen is operably coupled to the central computer 70. Residing in memory at the central computer are the menus and a processing algorithm for interpreting touch locations and generating order codes and associating them with an individual order. Communication means 50 which are known in the art and which can incorporate wire or wireless connection, are necessarily provided to operably couple the order station, the central computer, and the payment station 25. A printer may also be incorporated in the order station for printing order receipts.

B. Payment Phase.

After an order in placed, the customer proceeds to the payment station 25 to pay for the order. Separate order and payment stations are preferred as the ordering phase is expected to take substantially more time on the average than the payment phase. Accordingly, substantially fewer payment stations can service customers from a larger number of order stations, thereby reducing equipment costs and increasing efficiency. However, an order station and a payment station can be combined into a single unit if desired.

Each payment station has a payment selection means for selection by the customer of one or more forms of payment, a payment acceptance means for the automated acceptance of payment in the forms selected by the customer, computer means, and communication means for forwarding the components of the paid order to each of the restaurants from which a menu item has been ordered. Each of the payment stations may have a computer means consisting of a processor and memory or one of the payment stations may include the central computer for the apparatus of the present invention. Alternatively, the payment stations and the other components of the apparatus may be connected to a central computer 70 at a separate location such as an office adjacent to the food court or at a remote location connected to the food court by wire or wireless communication means 50 known in the art. The central computer will transmit order payment information to each of the restaurants.

The payment selection means will preferably incorporate a touch screen for use by the customer in selecting the forms of payment. The payment acceptance means will preferably include at least a coin acceptor, a currency acceptor, a credit/debit/EBT card acceptor, and a coupon acceptor. It will also preferably include a printer for printing a payment receipt and communication means to forward order and identification data to the restaurants. The central computer, whether included in a payment station or not, will include software for generating sales and revenue data for each restaurant and other accounting information.

After placing an order and receiving the order receipt, the customer enters an order code into the payment station. The code may be alphanumeric or may be a bar code printed on the receipt with entry accomplished by scanning the bar code. The payment station then prompts the customer for payment. The customer then enters payment by indicating a method, such as coupon, currency, coin, check, credit/debit/EBT/biometric card and proceeding to tender payment. After payment is confirmed, the payment station, through its own computer means or through the central computer, distributes the order to the restaurants for fulfillment. The payment station may issue a payment receipt or may simply confirm the order and the customer may use the order code from the original order receipt for use in verifying identity of the customer to the restaurants. The payment receipt may include a payment code which can be used to pick up the menu items from each restaurant, thereby preventing mis-delivery or theft. The payment code can be a payment bar code. Alternatively, the payment station may sense a biometric feature of the customer, such as a fingerprint, palm print, facial image or any other imaginable biometric feature to associate the order and payment thereof to the customer. For such embodiments, the restaurants will also require biometric sensors to sense the biometric feature of the customer and transmit the data to the central computer for identity verification.

Redundancy can be built into the system through the use of payment stations each of which has a computer means consisting of a processor and memory. Then by linking each payment station and the rest of the system components, the potentially debilitating effect of component failure can be minimized or eliminated.

C. Service Phase.

After the payment is received, the order is parsed to the individual restaurants to fulfill. In a preferred embodiment, selected menu items are displayed on individual restaurant touch screens 30 within the restaurants 40. A touch screen is preferred over a monitor and a keyboard or a mouse, or other equipment known in the art because it requires less space, is easier to use, and is less likely to be fouled by a typical restaurant environment. Employees can easily ascertain selected menu items for each order and easily confirm the preparation or readiness of the selected menu items for delivery. Screens are also commonly used in many fast food restaurants to communicate orders to employees preparing food, therefore little change is needed in a typical restaurant's standard operating procedure. Once a selected menu item is completed, the employee preparing the menu item simply touches the screen to indicate completion. The input is processed by the central computer 70, which then displays a notice on a delivery display 35 located within the food court area. Ideally, more than one such display would be beneficial, especially for larger dining areas. The customer then proceeds to the restaurant, confirms his identity through the selected identification method, and takes the food. Notices on the delivery display may be cleared automatically by being timed out or by the customer identity confirmation, or may be cleared by input to a touch screen or the like.

D. Accounting Phase.

A statistical analysis of orders will be necessary in order to divide proceeds from the method and apparatus. Since the payments will be processed communally, but menu item preparation and service will not, periodic accounting is necessary to allow distribution of payment revenue to the restaurants. Menu item sales data allow the restaurants to make analyses regarding menu item popularity and profitability and will be important for each restaurant for operation and advertising. Order statistics and revenue information will preferably be generated and downloaded or printed at the central computer 70, which may be incorporated in one of the payment stations as illustrated in FIG. 2 or may be a local or remote stand alone unit. A share of the proceeds and a statistical report are forwarded to the restaurants on an agreed periodic basis.

E. Alternate Embodiments.

A preferred embodiment of the method and apparatus for the common ordering and payment system has been described. However, other alternative embodiments may also be used. One alternate embodiment combines the order and payment stations into a single unit. This embodiment reduces equipment cost as duplicate printing, scanning, and other components of the centers may be eliminated. However, it should be noted that, in most circumstances, the ordering phase of the method takes a longer time than the payment phase. As such, a single payment station can service multiple order stations and this is the reason that separate order stations and payment stations are preferred.

A second alternate embodiment uses customer biometric features for customer and order identification. A fingerprint, facial image or other biometric feature may be taken at the time of the initial ordering and the biometric data may thereafter be associated with the order through the entire method to delivery, to facilitate customer identification and accurate order delivery.

Referring to FIG. 3, a third alternate embodiment incorporates an automated order delivery system. The delivery system would comprise a computerized delivery conveyor 65 or similar apparatus. This would allow orders to be routed to a drive-through window or a shared delivery area 80. The drive through or shared delivery area would comprise at least one delivery port area 85. The orders would then be routed to these port areas based on identifying port area numbers or other identification via a routing means 90 on the computerized delivery conveyor 65. Such a routing system could include a sensing means 95 to identify orders and a physical distribution means 100 to distribute the orders to distribution conveyors 105, thereby distributing the orders to designated delivery port areas 85.

A fourth alternative embodiment incorporates modular, stand alone components which are plug and operate. The order stations each have an order computer means including a processor and memory. The order stations generate an order receipt and transmit an order total to each of the payment stations. The customer then scans the order receipt at the payment station, selects the manner of payment and makes payment. The order stations also parse the order to each restaurant and transmit to each restaurant where the selected menu items for each restaurant show up on the restaurant screen which preferably is a touch screen. When payment is made for the order, the payment stations transmit payment confirmation by order number to each restaurant. The payment stations each have payment computer means including a processor and memory. The selected menu items are then identified as paid on the restaurant screen. Each restaurant can elect to begin selected menu item preparation upon initial appearance on the restaurant screen of the selected menu item information from an order station or can wait until payment confirmation from a payment station appears on the restaurant screen. Selected menu item preparation is confirmed by employee input on the restaurant screen. Each restaurant screen is also equipped with a restaurant computer means including a processor and memory. Selected menu item preparation confirmation is transmitted by each restaurant to the delivery display. The delivery display may also be equipped with delivery computer means including a processor and memory that can aggregate selected menu items for each order for the delivery display so that as menu item preparation is complete it shows up under the order number on the delivery display.

A fifth alternative embodiment may utilize speech recognition for selections and commands from the customers at the order stations and the payment stations, and from the restaurant employees at the advising means and service means. Likewise speech recognition and even voice recognition may be used by the service means to prevent order mis-delivery and theft.

Other embodiments and other variations of the embodiments described above will be obvious to a person skilled in the art. Therefore, the foregoing is intended to be merely illustrative of the invention and the invention is limited only by the following claims.

1. Method for operating a food court, the food court comprising a plurality of restaurants, the method comprising:
a) order step for automated acceptance for each customer of a respective customer's order of selected menu items from one or more of the restaurants;
b) payment step for automated acceptance of payment from each customer in one or more forms selected by the customer for the customer's order;
c) advising step of electronically advising each restaurant of selected menu items from the restaurant in each customer's order;
d) service step of each restaurant preparing selected menu items from the restaurant for each customer's order and making the selected menu items available for delivery to the customer; and
e) accounting step for automated accounting of sales revenue for menu items sold by each restaurant.

2. Method as recited in claim 1 wherein each customer utilizes an order touch screen for the order step.

3. Method as recited in claim 1 wherein the order step generates an order receipt containing a respective order code for each customer's order and the payment step includes acceptance of the order code from the customer.

4. Method recited in claim 3 wherein the order code for each customer's order is an order bar code and the payment step includes scanning the order bar code.

5. Method recited in claim 1 wherein the order step for each customer includes sensing a biometric feature of the customer for order identification purposes and the payment step includes sensing the biometric feature of the customer to identify the order for which payment is to be made.

6. Method as recited in claim 5 wherein the service step for each customer includes sensing the biometric feature of the customer to prevent order mis-delivery and theft.

7. Method as recited in claim 1 wherein each customer utilizes a payment touch screen for the payment step for selection of the forms of payment.

8. Method as recited in claim 1 wherein the payment step includes sensing a biometric feature and generating a biometric code for each customer and using the biometric code to confirm the identity of the customer and the customer's authorization to make payment in the forms selected.

9. Method as recited in claim 1 wherein the advising step and the service step utilize one or more restaurant touch screens in each restaurant for advising restaurant personnel of selected menu items for the restaurant for each customer's order and for allowing restaurant personnel to electronically confirm the preparation of the selected menu items.

10. Method as recited in claim 1 wherein the payment step generates a payment receipt for each customer's order.

11. Method as recited in claim 10 wherein the payment receipt includes a payment code and the service step includes acceptance of the payment code to prevent order mis-delivery and theft.

12. Method as recited in claim 11 wherein the payment code is a payment bar code and the service step includes scanning the payment bar code.

13. Method as recited in claim 1 wherein the accounting step includes tabulation of menu item sales for each restaurant.

14. Method as recited in claim 1 wherein the accounting step includes tabulation of menu item sales revenue for each restaurant.

15. Method as recited in claim 14 wherein the accounting step includes determination of each restaurant's share of the total food court revenue.

16. Method as recited in claim 1 wherein the service step includes one or more employees of the restaurant, from which a selected menu item has been ordered, preparing the selection and acknowledging that the selected menu item is ready for delivery through use of a touch screen and a delivery display.

17. Method as recited in claim 1 wherein the order step and the payment step are accomplished at one or more combined order and payment stations.

18. Method as recited in claim 1 wherein the order step, the payment step, the advising step, the service step and the accounting step are accomplished through the use of a central computer.

19. Method as recited in claim 1 wherein the service step includes electronically advising the customer that the selected menu items are ready for delivery.

20. Method as recited in claim 1 wherein the service step includes delivering the order to an automated conveyor delivery system.

21. Method as recited in claim 20, wherein the automated conveyor system comprises:
a) order sensing means for order identification; and
b) order routing means for delivering menu items of respective orders to selected delivery locations.

22. Apparatus for automated food court operation, the food court comprising a plurality of restaurants, the apparatus comprising:
a) order means for automated self-service selection of menu items by customers from menu offerings for each restaurant;
b) payment means for automated self-service payment by customers for orders placed;
c) advising means for advising each restaurant of menu items ordered and menu items paid for by customers;
d) service means for advising customers of ordered menu items which are ready for delivery; and
e) accounting means for automated accounting of sales revenue for menu items sold by each restaurant.

23. Apparatus as recited in claim 22 wherein the order means includes an order touch screen.

24. Apparatus as recited in claim 22 wherein the order means further comprises an order printing means for generating an order receipt containing an order code and the payment means further comprises an order code input means for accepting the order code from the customer.

25. Apparatus as recited in claim 24 wherein the order code is an order bar code and the order code input means comprises an order bar code scanner.

26. Apparatus as recited in claim 22 wherein the order means further comprises an order biometric sensing means for sensing a biometric feature of the customer for order identification purposes and the payment means further comprises a payment biometric sensing means for sensing the biometric feature of the customer to identify the order for which payment is to be made.

27. Apparatus as recited in claim 26 wherein the service means further comprises a service biometric sensing means for sensing the biometric feature of the customer to prevent order mis-delivery and theft.

28. Apparatus as recited in claim 22 wherein the payment means includes a payment touch screen for customer selection of methods of payment.

29. Apparatus as recited in claim 22 wherein the advising means and the service means include one or more restaurant touch screens in each restaurant for advising restaurant personnel of selected menu items for the restaurant for each customer's order and for allowing restaurant personnel to electronically confirm the preparation of the selected menu items.

30. Apparatus as recited in claim 22 wherein the payment means further comprises a payment printing means for generating a payment receipt.

31. Apparatus as recited in claim 30 wherein the payment receipt includes a payment code and the service means further comprises payment code input means for acceptance of the payment code to prevent order mis-delivery and theft.

32. Apparatus as recited in claim 31 wherein the payment code is a payment bar code and the payment code input means comprises a payment bar code scanner.

33. Apparatus as recited in claim 22 wherein the accounting means includes means for generating a tabulation of menu item sales for each restaurant.

34. Apparatus as recited in claim 22 wherein the accounting means includes means for determining each restaurant's share of the total food court revenue.

35. Apparatus as recited in claim 22 wherein the service means comprises individual restaurant touch screens in each restaurant operably coupled to at least one delivery display screen in the dining area whereby employees of each restaurant confirm that menu items are ready for delivery.

36. Apparatus as recited in claim 22 wherein the order means and the payment means are combined.

37. Apparatus as recited in claim 22 further comprising central computer means and communication means, the communication means linking the central computer means to the order means, the payment means, the advising means and the service means.

38. The apparatus as recited in claim 22 further comprising an automated delivery conveyor system.

39. The apparatus as recited in claim 38, wherein the delivery conveyor system comprises:
a) order sensing means for order identification; and
b) order routing means for delivering menu items of respective orders to designated delivery locations.

40. Apparatus for automated food court operation, the food court comprising a plurality of restaurants, the apparatus comprising:
a) one or more order stations;
b) one or more payment stations;
c) one or more restaurant touch screens in each restaurant;
d) one or more delivery screens;
e) central computer; and
f) communication means for linking the central computer to the order stations, the payment stations, the restaurant touch screens, and the delivery screens.

41. The apparatus as recited in claim 40 further comprising an automated delivery conveyor system.

42. The apparatus as recited in claim 41, wherein the delivery conveyor system comprises:
a) order sensing means for order identification; and
b) order routing means for delivering menu items of respective orders to designated delivery locations.
